(19) United States
(12) Patent Application Publication
(10) Pub. No.: US 2014/0081428 A1
(43) Pub. Date: Mar. 20, 2014

(54) SYSTEM FOR LOCATING A MACHINE AND/OR A PART IN A COORDINATE SYSTEM

(71) Applicants: Todd W. Rudberg, Shoreline, WA (US); Joshua M. Cemenska, Mukilteo, WA (US)

(72) Inventors: Todd W. Rudberg, Shoreline, WA (US); Joshua M. Cemenska, Mukilteo, WA (US)

(21) Appl. No.: 13/622,214

(22) Filed: Sep. 18, 2012

(51) Int. Cl. G05B 19/02

(52) U.S. Cl. CPC G05B 19/02
USPC 700/66

(57) ABSTRACT

The system includes a software program for locating a machine in a fixed reference coordinate (FRC) system for a manufacturing system, such as a fiber placement machine used in the construction of a composite part. The software system also locates a part in the FRC, and further includes locating an optical tool point in space by using laser information from known two positions to determine the position of the optical tool point.

### TECHNICAL FIELD

This invention relates generally to the determination of the location of various components in automated manufacturing systems or cells by the use of laser measurement systems, and more specifically concerns a system that uses laser triangulation to locate the components of the manufacturing system.

### BACKGROUND OF THE INVENTION

In one such manufacturing system, the operation of an automatic fiber placement system (AFP) requires that the strips of composite material be accurately positioned on a surface member, which ultimately results in a composite part. Such composite parts are used in various assemblies, including parts of large aircraft, such as the fuselage thereof. Composite parts are also used in a number of other applications. An AFP system typically includes a CNC-controlled machine for laying down individual strips of fiber onto a tool, or onto prior layers of fiber, to form a part. The CNC machine can include a number of separate spools of material which can be utilized simultaneously to produce a complex arrangement of fiber strips in the construction of the composite part.

Briefly, the composite material laid on the surface member to produce the part is in the form of narrow strips, also called tows, with the CNC machine controlling how many tows are laid in one path onto the surface member. In order for the individual tows to be laid accurately, and also to permit accurate inspection of any portion of the fiber placement, as well as verification thereof, it is necessary for the machine, the laser projector and the part to be accurately located relative to each other.

Existing laser projector system registers are located into part coordinates via a single rigid body 6 degree of freedom (6DOF) transform, defining the laser projector origin relative to the part origin. This transform indicates the laser's origin in the part system and the transform from the part space to the laser space as well as the part origin to the laser projector origin.

To obtain the transform, the operator currently uses an application interface created by the laser manufacturer to manually steer the laser beam to multiple retro-reflective targets located on the surface member at known part coordinates. For each target, the laser captures two mirror angles from retro-reflectors on the surface member which describe the deviation of the laser vector (the laser ray) from the laser to the target point relative to a normal (perpendicular) vector of the laser. The operator inputs the known location of each target into the laser software in part coordinates. Using the defined location and the mirror angles for each target, the laser calculates its own position and orientation in the defined coordinate space and uses that data to create a transform between the laser coordinates and the part coordinates. While the above system can work appropriately in some cases, in other cases the surface member may be displaced or the CNC machine may be mobile, brought into the overall system, such as by a crane or other member. It is important to be able to quickly and accurately position the machine and the part within the overall system. Not having to make physical contact between the tool point of the machine and the part is desirable.

Other manufacturing system would benefit from being able to locate a tool or part without contact, and being able to accurately project verification information onto the resulting part. For example, a drill and riveting machine for attaching wing skins to airplane spars must be able to accurately locate the skin-spar assembly in order to properly drill holes, despite the flexibility of the system before clamp-up, and then laser project a verification pattern to demonstrate the intended hole locations before the drilling begins or to verify the proper location of the riveted holes at the end of the process.

In another example, an edge trimming machine for carbon fiber composites must be able to locate the same tool used in carbon fiber layup relative to itself, or the FRC (fixed reference coordinates) of its production cell, project the desired cut shape to verify tha the part to be cut is the proper one and is properly located such that the desired part is going to overlap the previously laid up material, and then cut the part to the final shape within the specified tolerance of the final part.

Hence, it would be advantageous to quickly and accurately locate parts and/or machines in an FRC system, and also to be able to locate a particular point in the system. Determining a number of points would permit non-contact probing of the part and the generation of a transform between the FRC and the part.

### SUMMARY OF THE INVENTION

Accordingly one aspect of the present invention is a system for locating the position of a movable machine in a fixed reference (FRC) coordinate system which also includes a laser projector and a part, wherein the laser projector is registered in the FRC, the locating system comprising: a software system for calculating and storing the coordinate transform relating the laser projector to the FRC, for retrieving the stored transform for the machine tool point to the laser projector and for creating a transform indicating the position of the machine in the FRC by multiplying the transform for machine tool point to the laser projector and the projector to the FRC transform.

Another aspect is a system for locating the position of a part in a fixed reference coordinate (FRC) system for a manufacturing system, which also includes a CNC machine and a laser projector, wherein the laser projector is registered in the FRC, the locating system comprising: a software system which calculates and stores the transform relating the position of the laser projector relative to the FRC, inverting the transform of the projector to the part, producing a transform relating the part to the laser projector following registration of the laser projector to the part by the user, and producing a transform relating the part to the FRC by multiplying the transform of the part relative to the laser projector and the transform of the projector relative to the FRC.

Another aspect is a system for point probing a part in a manufacturing system which includes a CNC machine motion platform, a laser projector registered in a fixed reference coordinate system (FRC) at a known location, and mounted at a known location on the motion platform, the point probing system comprising: a software system for commanding the motion platform to move to a first known position; steering the laser projector by an optical tool point to be measured, scanning the optical tool point and returning for location information back to the laser projector, moving the motion platform to a second known position and repeating the steering, scanning and returning functions, wherein the software uses the returning information to calculate the position of the optical tool point in the FRC.

Still another aspect is a system for locating the position of a machine relative to a part coordinate system or locating a part relative to a tool coordinate system, which includes a laser projector connected to control software, a CNC machine and a part or tool, the locating system comprising: a software system for calculating and storing a coordinate transform relating the laser projector to the part, for calculating a transform from machine tool point to the laser projector and for creating a transform indicating the position of the machine in the part coordinate system by multiplying the transform for machine tool point to the laser projector by the transform of the laser projector to the part.

A further aspect is a system for calculating the location of a laser projector as it is affected by the motion of the CNC machine in a manufacturing system which includes a CNC machine, a laser projector mounted on the CNC machine and a computational model of the motion of the machine which includes the position of the laser, wherein the laser projector is registered into a fixed coordinate system, the location calculating system comprising: a software system for modeling motion of each axis of the CNC machine such that the position and orientation of the laser can be computed give a commanded or actual machine axis position or machine tool point position, further such that a transform from a laser registration position to the current position can be calculated, and still further that the inverse of the transform is useful to create projections in the same coordinates as the laser was registered into.

### BRIEF DESCRIPTION OF THE DRAWINGS

FIG. 1 shows a diagram of a fiber placement system.

FIGS. 2 and 2A show diagrams for measuring a point in space using two positions of the machine.

FIGS. 3-8 show software flowcharts for aspects of the present system.

FIG. 9 is a calculation solution.

### BEST MODE FOR CARRYING OUT THE INVENTION

The following manufacturing system (automatic fiber placement) is one example of an application of the present invention. It is a suitable example for a detailed explanation of the present invention. As indicated above, it is important that an automatic fiber placement system have a fixed coordinate system or reference system in which all of the components of the AFP system can be accurately located. This maintains the accuracy of the placement of the tow during operation of the system, including when the CNC machine is movable and when the surface member is displaced in operation. For instance, the surface element may be positioned on a rotatable mandrel axis imprecisely, or during rotation the surface element may shift or translate as a result of various factors, such as surface member deflections, gravity deflections or various moments in the physical support structure. The accuracy of the fiber placement and subsequent laser projection is compromised in those cases.

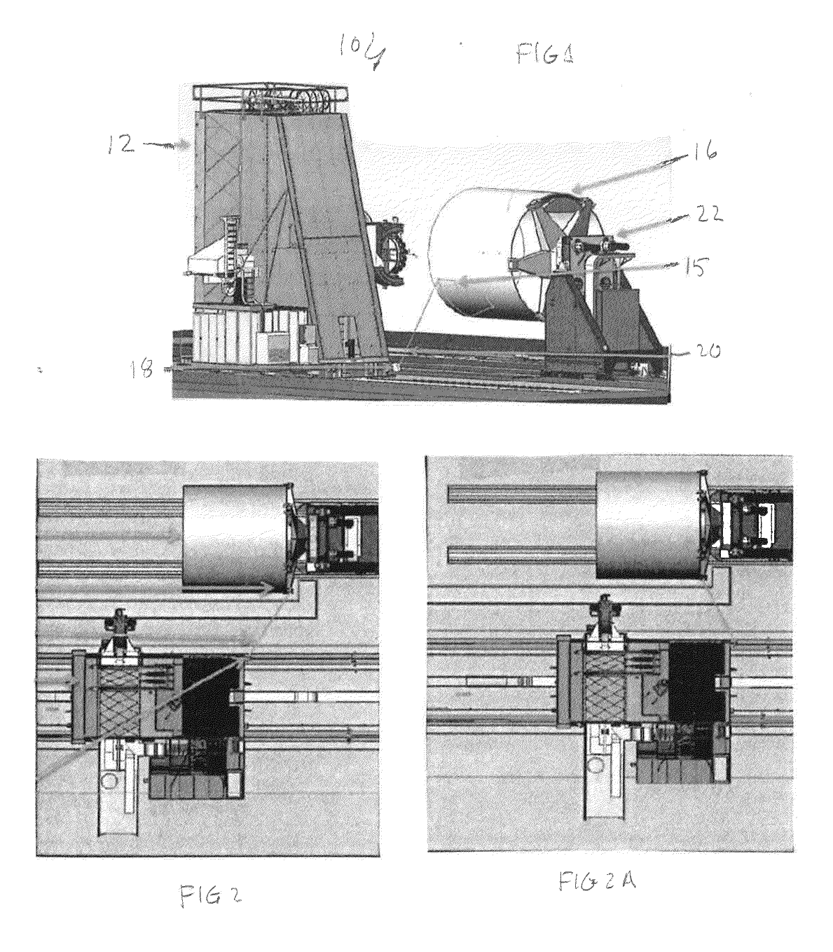

A fiber placement system is shown generally at 10 in FIG. 1. It includes a machine 12, which is a multiple degree of freedom motion platform and includes a head 14, which contains spools of composite fiber tow. In operation, the material is positioned on a surface element 16 in accordance with a specific pattern established in a build program provided in the CNC machine. A representative fiber ply boundary is shown at 15. The result is a final composite part.

A laser projector 18 is mounted on the machine and projects onto the surface member. The laser projector is also controlled by a part program. A laser beam 20 is also shown. The surface member is moved/rotated by a rotating mandrel assembly 22. As indicated above, the machine may be moved into the vicinity of the surface member during set up.

In one aspect of the present invention, a machine can be located within the fixed reference coordinate system (FRC). The requirements for this action include a laser projector which is in communication with the computer running the control software. The FRC refers to fixed reference coordinates, a common coordinate system defined by physical benchmarks within it. The mobile machine also must have a known relationship to the laser projector; in particular, the transform for the machine tool point relative to the projector must be known.

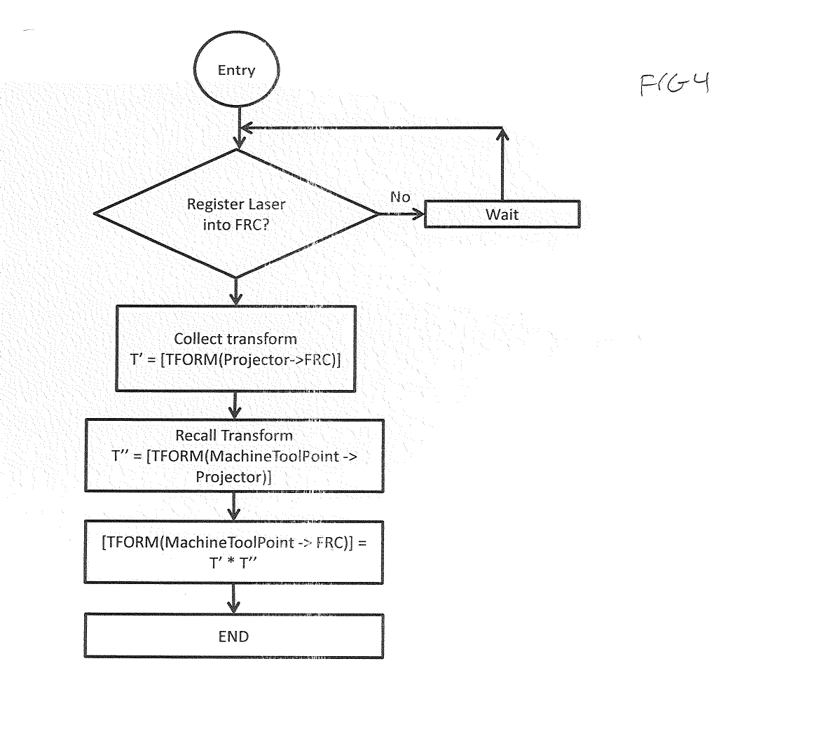

Referring to FIG. 3, the user interface displays the following steps in sequence. The mobile machine is first placed in the machining cell or vicinity, at 30. The laser projector is then registered into the machine cell FRC, at 32. This occurs by a procedure defined by the manufacturer of a particular laser projector.

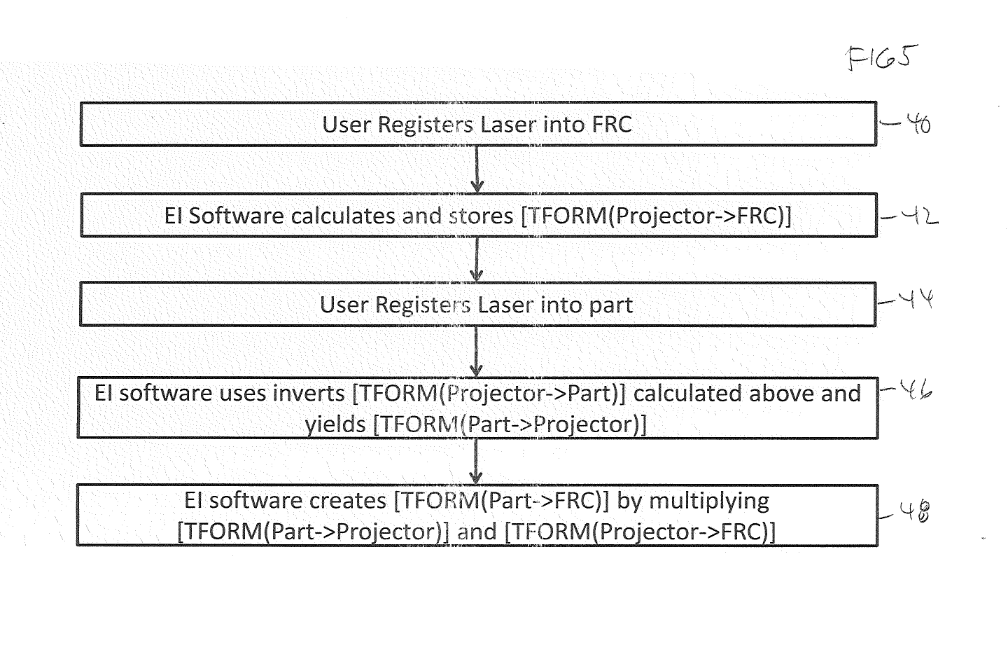

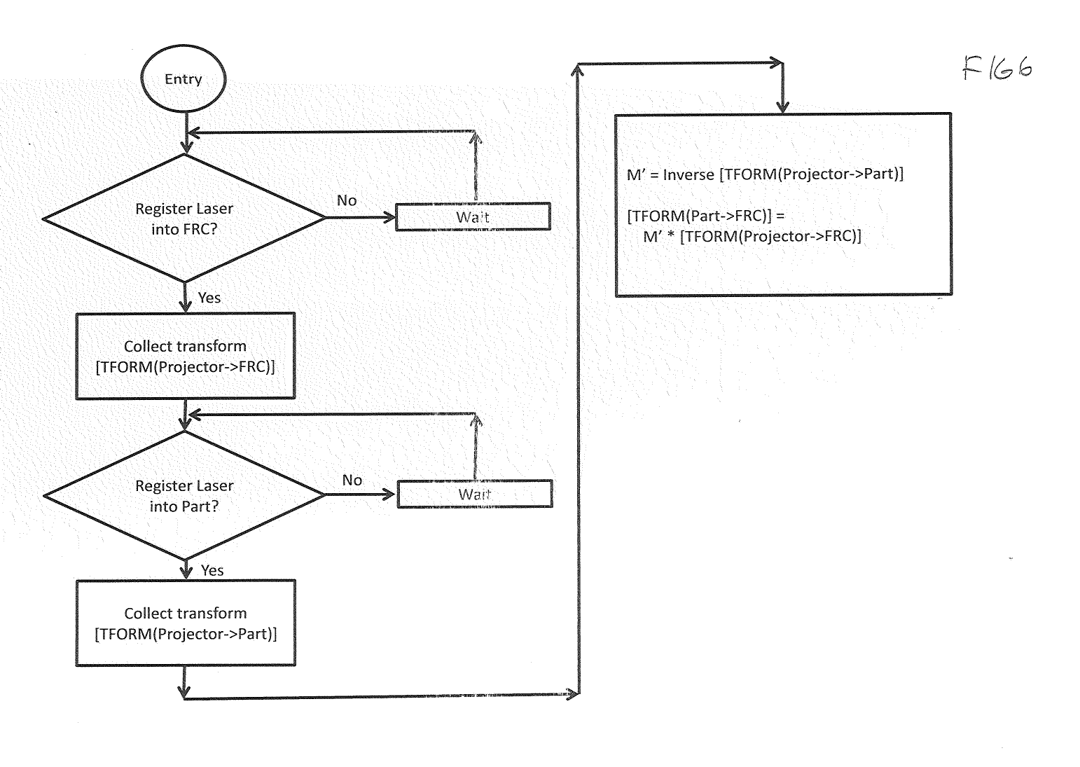

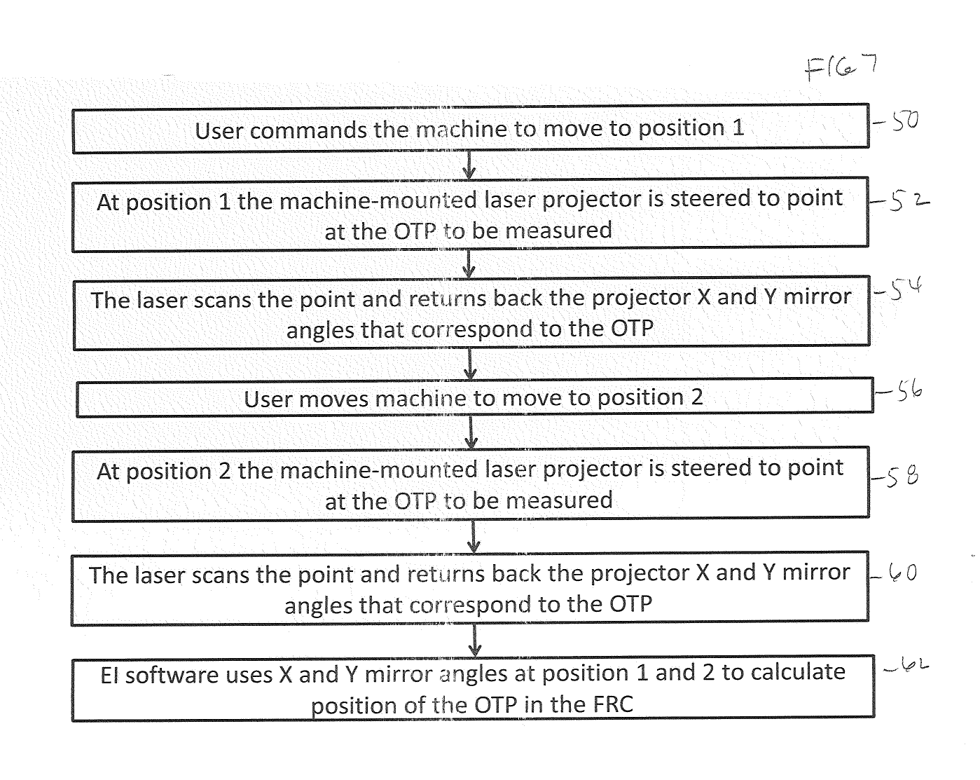

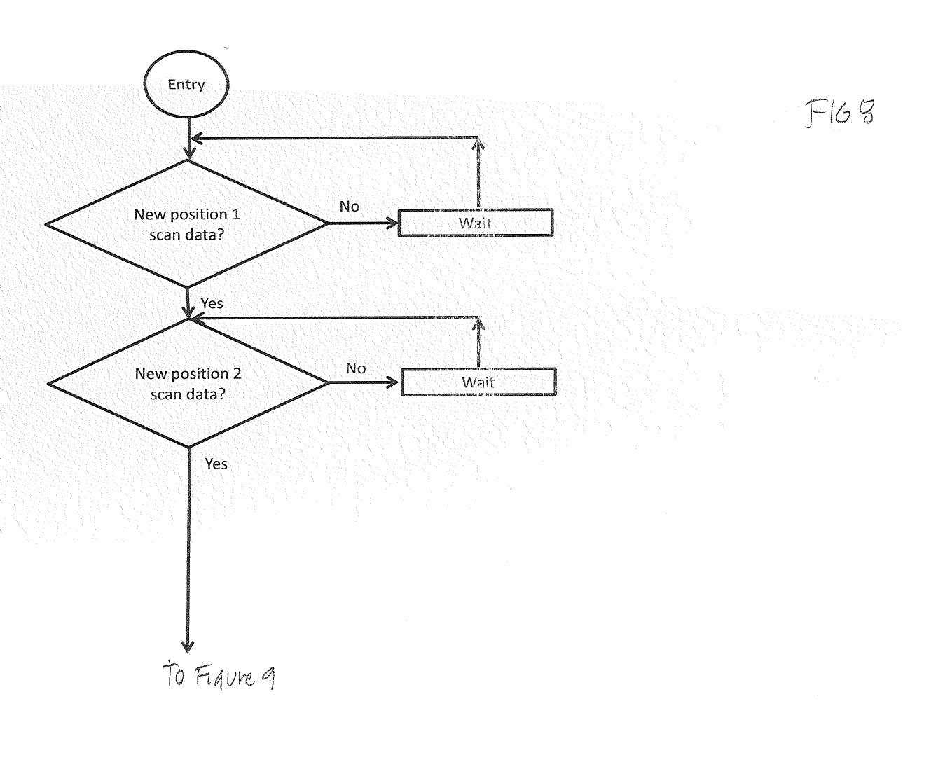

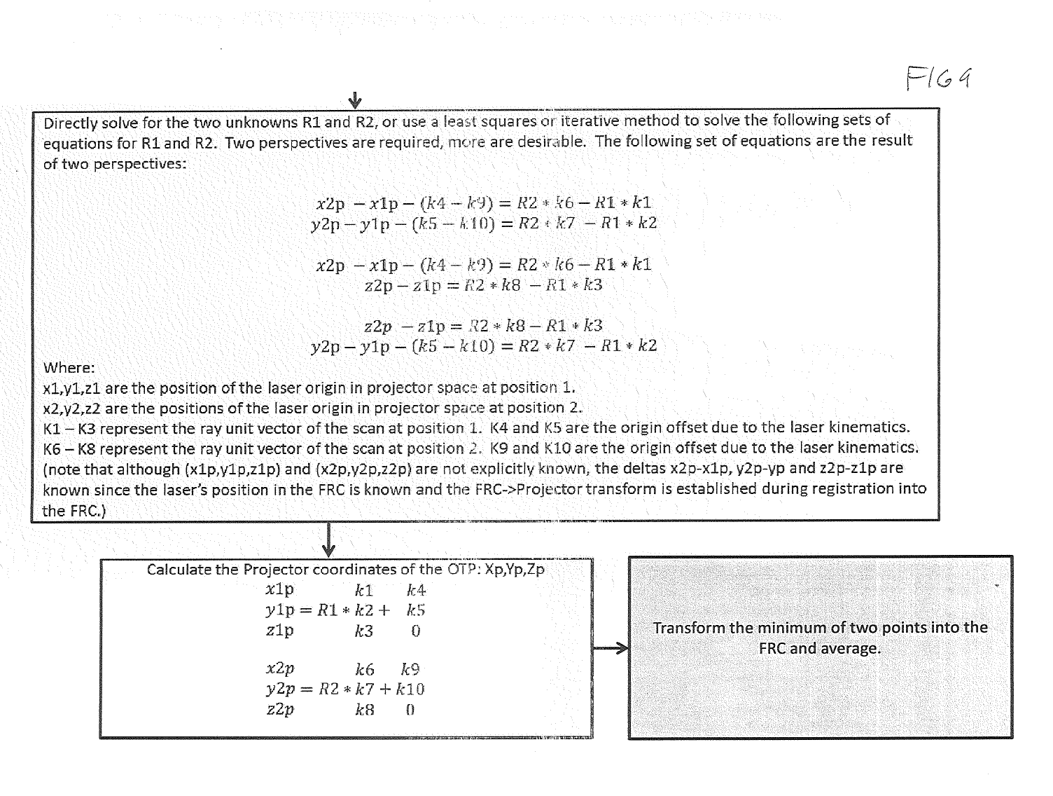

The software then calculates and stores the transform for the laser projector to the FRC, at 34. The software at 36 next recalls the previously stored transform (known) relating the machine tool point relative to the laser projector. The software at 38 then creates a new transform relating the FRC to the machine by multiplying the transform of the machine tool point to the laser projector and the transform of the laser projector to the FRC. This new transform locates the machine tool point in the FRC. The corresponding calculation steps are shown in software format in FIG. 4. The location of other parts of the machine can be solved by using conventional techniques of reverse kinematics. The above information provides the important location of the machine in the FRC for the manufacturing system. As indicated above, it is important to reliably know where the machine is in the system FRC. This permits the use of a mobile machine in the manufacturing system.

Another aspect of the present system is location of the part in the FRC. The requirements for this aspect of the system are again a laser projector with a communication capability with the system computer software, an FRC, defined by fixed physical benchmarks, a part with references thereon, i.e. a part within a coordinate system established by physical benchmarks.

FIG. 5 shows the user interface display steps, while the software calculations are shown in FIG. 6. As with the machine location, the user first registers the laser projector into the existing FRC. This is part of the normal operation of the laser projector, as explained above. The software at 42 then calculates and stores the transform for the laser projector to the FRC at 42. The user then performs an operation by registering the laser projector relative to the part, and obtains the transform therefor. The software then inverts the transform for the laser projector to the part, which results in a transform of the part to the laser projector. The software then creates a new transform for the part to the FRC by multiplying the transform of the part to the projector and the transform of the laser projector to the FRC. The related software calculations are shown in FIG. 6.

The present system also allows the location of a point in space with the laser projector, also known as point probing. The requirements of the system again include a laser projector with communication with the computer running the control software, as well as a fixed reference coordinate (FRC). Two spaced viewpoints are necessary for the laser projector in this aspect of the system. This can either be a single projector that moves to two locations or two stationary projectors. The desired single optical tool point (OTP) to locate, such as a retro-reflective target on the part, must be visible to the projector from both viewpoints. The position and orientation of the laser in the FRC must also be precisely known at each viewpoint. Again, the goal is to locate a single point in the FRC. In the initial setup, the transform between the laser projector to the FRC is known and the location of the laser projector at each viewpoint is established, by accounting for the displacement from the registration position at each location.

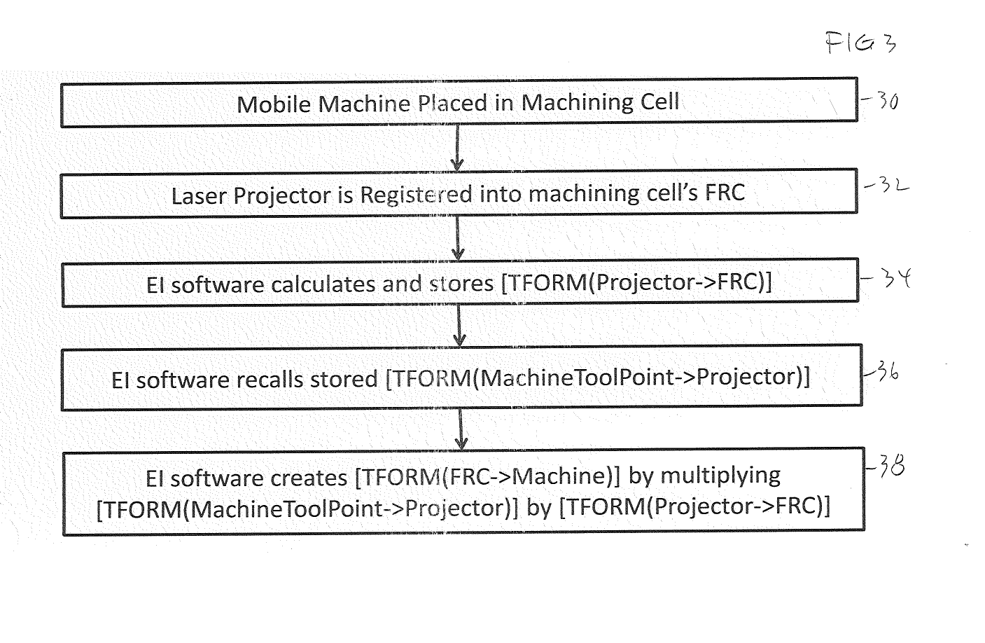

The user interface display is shown in FIG. 7. The user first commands the machine to move to position 1, as shown in FIG. 2 and at 50 in FIG. 7. As indicated in the above system, the location of the machine in the FRC is known at this position. At position 1, the laser projector mounted on the machine is steered or maneuvered to point at the retro reflective target, i.e. the point to be identified, at block 52. At 54, the laser projector scans the point and returns back to the laser projector X and Y mirror angles that correspond to the retro reflective target being measured.

The user then moves the machine to position 2, which movement must include a non-zero translation component, as shown at 56 and in FIG. 2A. At 58, the machine-mounted laser projector is steered to the same optical tool point, at 60. The laser projector then scans the same point and returns back to the projector X and Y mirror angles that correspond to the retro reflective target, at 62. The software then uses the X and Y mirror angles at positions 1 and 2 to calculate the position of the optical tool point in the FRC. The corresponding software calculation steps are shown in FIG. 8. The detailed position calculation is relatively straightforward and is shown in FIG. 9. It is important to understand that the calculation in FIG. 9 is a basic geometric calculation to locate the target point and that averaging additional perspectives (more than two) on the point or using an iterative solver to locate the point will result in potentially higher accuracy.

The above system enables the machine, in particular the tool point, to accurately interact with the part, with a non-contact arrangement, referred to as point probing herein. This provides an ability to probe a part without actual physical contact. This can be used to locate a particular part and probe a large number of said locations on a part automatically with minimum operator setup and intervention, without the necessity of moving a physical probe to each location. This allows for generating a kinematic model of the part for future interaction between the tool point, the laser projector and the part. In addition, it can be used to approximately locate a part in the FRC, such that an actual touch probe can be used with a program to automatically produce a more accurate location of the part with a much smaller risk of damage to the touch probed part on the machine due to its movement to undesired positions. Faster machine action results, since the present arrangement slows the operation of the machine to reduce risk of damage.

Accordingly, a system has been described which results in a mobile machine being locatable in an FRC system for a fiber placement system for part construction. In addition, the part itself can be accurately located in the FRC as well as a point in space, e.g. an optical tool point, thereby providing a non-contact probing arrangement. All of the above locating processes use a laser system that can measure angle but do not need to measure distance.

The above specific system is a fiber placement machine. Other systems include an additive manufacturing machine, an automated tape laying machine, an automated drilling machine, an automated riveting machine, a cutting machine, a routing machine and an edge trimming machine.

Although a preferred embodiment of the invention has been disclosed for purposes of illustration, it should be understood that various changes, modifications and substitutions may be incorporated in the embodiment without departing from the spirit of the invention, which is defined by the claims which follow.

What is claimed is:

1. A system for locating the position of a movable machine in a fixed reference (FRC) coordinate system which also includes a laser projector and a part, wherein the laser projector is registered in the FRC, the locating system comprising:
a software system for calculating and storing the coordinate transform relating the laser projector to the FRC, for retrieving the stored transform for the machine tool point to the laser projector and for creating a transform indicating the position of the machine in the FRC by multiplying the transform for machine tool point to the laser projector and the projector to the FRC transform.

2. A system of claim 1, wherein the machine, the laser projector and the part form a machining system or cell.

3. A system of claim 2, wherein the laser projector is registered into the machine cell in a manner defined by a manufacturer of the laser projector.

4. A system of claim 1, where the CNC machine is an additive manufacturing machine.

5. A system of claim 1 where the CNC machine is an Automated Fiber Placement Machine.

6. A system of claim 1 where the CNC machine is an Automated Tape Layer.

7. A system of claim 1 where the CNC machine is an Automated Drilling Machine.

8. A system of claim 1 where the CNC machine is an Automated Riveting Machine.

9. A system of claim 1 where the CNC machine is a cutting machine

10. A system of claim 1 where the CNC machine is a routing machine.

11. A system of claim 1 where the CNC machine is an edge trimming machine.

12. A system for locating the position of a part in a fixed reference coordinate (FRC) system for a manufacturing system, which also includes a CNC machine and a laser projector, wherein the laser projector is registered in the FRC, the locating system comprising:
a software system which calculates and stores the transform relating the position of the laser projector relative to the FRC, inverting the transform of the projector to the part, producing a transform relating the part to the laser projector following registration of the laser projector to the part by the user, and producing a transform relating the part to the FRC by multiplying the transform of the part relative to the laser projector and the transform of the projector relative to the FRC.

13. A system of claim 12, wherein the laser projector is registered into the manufacturing system in a manner defined by the manufacturer of the laser projector.

14. A system of claim 12, where the CNC machine is an additive manufacturing machine.

15. A system of claim 12 where the CNC machine is an Automated Fiber Placement Machine.

16. A system of claim 12 where the CNC machine is an Automated Tape Layer.

17. A system of claim 12 where the CNC machine is an Automated Drilling Machine.

18. A system of claim 12 where the CNC machine is an Automated Riveting Machine.

19. A system of claim 12 where the CNC machine is a cutting machine

20. A system of claim 12 where the CNC machine is a routing machine.

21. A system of claim 12 where the CNC machine is an edge trimming machine.

22. A system for point probing a part in a manufacturing system which includes a CNC machine motion platform, a laser projector registered in a fixed reference coordinate system (FRC) at a known location, and mounted at a known location on the motion platform, the point probing system comprising:
a software system for commanding the motion platform to move to a first known position; steering the laser projector by an optical tool point to be measured, scanning the optical tool point and returning for location information back to the laser projector, moving the motion platform to a second known position and repeating the steering, scanning and returning functions, wherein the software uses the returning information to calculate the position of the optical tool point in the FRC.

23. A system of claim 22, where the CNC machine is an additive manufacturing machine.

24. A system of claim 22 where the CNC machine is an Automated Fiber Placement Machine.

25. A system of claim 22 where the CNC machine is an Automated Tape Layer.

26. A system of claim 22 where the CNC machine is an Automated Drilling Machine.

27. A system of claim 22 where the CNC machine is an Automated Riveting Machine.

28. A system of claim 22 where the CNC machine is a cutting machine

29. A system of claim 22 where the CNC machine is a routing machine.

30. The system of claim 22 where the CNC machine is an edge trimming machine.

31. A system for locating the position of a machine relative to a part coordinate system or locating a part relative to a tool coordinate system, which includes a laser projector connected to control software, a CNC machine and a part or tool, the locating system comprising:
a software system for calculating and storing a coordinate transform relating the laser projector to the part, for calculating a transform from machine tool point to the laser projector and for creating a transform indicating the position of the machine in the part coordinate system by multiplying the transform for machine tool point to the laser projector by the transform of the laser projector to the part.

32. A system for calculating the location of a laser projector as it is affected by the motion of the CNC machine in a manufacturing system which includes a CNC machine, a laser projector mounted on the CNC machine and a computational model of the motion of the machine which includes the position of the laser, wherein the laser projector is registered into a fixed coordinate system, the location calculating system comprising:
a software system for modeling motion of each axis of the CNC machine such that the position and orientation of the laser can be computed give a commanded or actual machine axis position or machine tool point position, further such that a transform from a laser registration position to the current position can be calculated, and still further that the inverse of the transform is useful to create projections in the same coordinates as the laser was registered into.

33. A system of claim 32, where the known laser position is used to generate known positions for using a laser projector to determine the orientation of an optical tooling point.
